(19) United States
(12) Patent Application Publication
(10) Pub. No.: US 2015/0184593 A1
(43) Pub. Date: Jul. 2, 2015

(54) Gas Turbine Energy Storage and Energy Supplementing Systems And Methods of Making and Using the Same

(71) Applicants: Robert J. KRAFT, Tequesta, FL (US); Pete SOBIESKI, Seabrook, TX (US)

(72) Inventors: Robert J Kraft, Tequesta, FL (US); Pete Sobieski, Seabrook, TX (US)

(21) Appl. No.: 14/357,136

(22) PCT Filed: Jan. 29, 2013
(86) PCT No.: PCT/US13/23545

§ 371 Date: May 8, 2014

Related U.S. Application Data
(60) Provisional application No. 61/592,158, filed on Jan. 30, 2012.

(51) Int. Cl. F02C 9/18; F01D 25/10

(52) U.S. Cl. CPC F02C 9/18; F01D 25/10

(57) ABSTRACT

The current invention provides several options, depending on specific plant needs, to improve the efficiency and power output of a plant at low loads, reduce the lower limit of power output capability of a gas turbine while at the same time increasing the upper limit of the power output of the gas turbine, thus increasing the capacity and regulation capability Of a new or existing gas turbine system. One aspect of the present invention relates to an energy storage and retrieval system for obtaining useful work from an existing source of a Gas Turbine (GT) power plant while preferably providing an efficient heated air inlet charger.

### FIELD OF THE INVENTION

The invention relates generally to electrical power systems, including generating capacity of a gas turbine, and more specifically to energy storage that is useful for providing additional electrical power during periods of peak electrical power demand while self consuming power generated by the gas turbine during times of reduced power demand.

### BACKGROUND OF THE INVENTION

Currently most marginal energy is produced mainly by gas turbine, either in simple cycle or combined cycle configurations. As a result of load demand profile, the gas turbine base systems are cycled up during periods of high demand and cycled down or turned off during periods of low demand. This cycling is typically driven by the Grid operator under a program called active grid control, or “AGC”. Unfortunately, because industrial gas turbines, which represent the majority of installed base, were designed primarily for base load operation, when they are cycled, a severe penalty is associated with the maintenance cost of that particular unit. For example, a gas turbine that is running base load could go through a normal maintenance once every three years, or 24,000 hours at a cost in the $2-$3 million dollar range. That same cost could be incurred in one year for a plant that is forced to start up and shut down every day.

Currently these gas turbine plants can turn down to approximately 50% of their rated capacity. They do this by closing the inlet guide vanes of the compressor, which reduces the air flow to the gas turbine, also driving down fuel flow as a constant fuel air ratio is desired in the combustion process. Maintaining safe compressor operation and emissions typically limit the level of turn down that can be practically achieved.

The safe compressor lower operating limit is improved in current gas turbines by introducing warm air to the inlet of the gas turbine; typically from a mid stage bleed extraction from the compressor. Sometimes, this warm air is also introduced into the inlet to prevent icing. In either case, when this is done, the work that is done to the air by the compressor is sacrificed in the process for the benefit of being able to operate the Gas Turbine at lower levels, thus increasing the turn down capability. This has a negative impact on the efficiency of the system as the work performed on the air that is bled off is lost. Additionally, the combustion system also presents a limit to the system.

The combustion system usually limits the amount that the system can be turned down because as less fuel is added, the flame temperature reduces, increasing the amount of carbon monoxide (“CO”) emissions that are produced. The relationship between flame temperature and CO emissions is exponential with reducing temperature, consequently, as the gas turbine system gets near the limit, the CO emissions spike up, so a healthy margin is kept from this limit. This characteristic limits all gas turbine systems to approximately 50% turn down capability, or, for a 100 MW gas turbine, the minimum power that can be achieved is about 50%, or 50 MW. As the gas turbine mass flow is turned down, the compressor and turbine efficiency falls off as well, causing an increase in heat rate of the machine. Some operators are faced with this situation every day and as a result, as the load demand falls, gas turbine plants hit their lower operating limit and have to turn the machines off which cost them a tremendous maintenance cost penalty.

Another characteristic of a typical gas turbine is that as the ambient temperature increases, the power output goes down proportionately (linearly) due to the linear effect of the reduced density as the temperature of air increases. Power output can be down by more than 10% from 59° F. standard day (ISO condition) during hot days, typically when peaking gas turbines are called on most to deliver the marginal energy described above.

Another characteristic of typical gas turbines is that air that is compressed and heated in the compressor section of the gas turbine is ducted to different portions of the gas turbine's turbine section where it is used to cool various components. This air is typically called “TCLA” which stands for “Turbine Cooling and Leakage Air” a term that is well known in the art with respect to gas turbines. Although heated from the compression process, TCLA air is still significantly cooler than the turbine temperatures, and thus is effective in cooling those components. Typically 10% to 15% of the air that comes in the inlet of the compressor bypasses the combustor and turbine and is used for this cooling process. This TCLA is a significant penalty to the performance of the gas turbine system.

### SUMMARY OF THE INVENTION

The current invention provides several options, depending on specific plant needs, to improve the efficiency and power output of a plant at low loads, reduce the lower limit of power output capability of a gas turbine while at the same time increasing the upper limit of the power output of the gas turbine, thus increasing the capacity and regulation capability of a new or existing gas turbine system.

One aspect of the present invention relates to an energy storage and retrieval system for obtaining useful work from an existing source of a Gas Turbine (GT) power plant while preferably providing an efficient heated air inlet charger.

Another aspect of the present invention relates to methods and systems that allow gas turbine systems to more efficiently provide additional power during periods of peak demand, while staying within the existing capabilities of the gas turbine and generator.

Another aspect of the present invention relates to methods and systems that allow gas turbine systems to be more efficiently turned down during periods of low demand.

Another aspect of the present invention is to store otherwise wasted heat during periods of charging the tank and using the stored heat energy later while discharging the tank to heat up the air being discharged from the tank.

Another aspect of the present invention is to use a hydraulically activated system to push all of the air out of the storage tank.

Another aspect of the present invention is to use the otherwise wasted heat during periods of charging the tank as input into another process, like a combined cycle plant or some other hot water system like district heating, to improve the overall efficiency of the system.

Another aspect of the present invention is to simultaneously discharge air from the tank and mix it with gas turbine TCLA to heat the injected air to proper temperatures and improve cooling effectiveness, both improving the gas turbine efficiency.

Another aspect of the present invention is to simultaneously deliver and mix air from the auxiliary compression system with air being discharged from the tank to provide increased power boost from the gas turbine while also providing an essential need of heating the injected air.

One embodiment of the invention relates to a system comprising an Air Booster Pump (ABP), connected to an existing gas turbine, a combustion case discharge manifold, and a high temperature heat exchanger having a first heat exchange circuit and a second heat exchange circuit.

One advantage of preferred embodiments is most of the compression work is done by the existing compressor and controlled within current operating limits with existing controls.

Another advantage of preferred embodiments of the invention is that the efficiency penalty associated with inlet (bleed) heating system is minimized because the bleed air from the gas turbine is not needed as hot air may be charged into the inlet of the gas turbine from the second circuit of the intercooler according to some preferred embodiments of the invention.

Another advantage of the preferred embodiment is that the boost compressor air can be diverted around the intercooler and mixed with the air being discharged from the air tank to provide a means or mechanism to heat the stored air up prior to injection into the gas turbine. Another advantage of other preferred embodiment is the ability to increase the turn down capability of the gas turbine system during periods of low demand and improve the efficiency and output of the gas turbine system during periods of high demand by storing the electrical energy from the gas turbine generator in the form of heated fluid with an induction heater and returning that energy later in periods of higher demand.

Another advantage of still further embodiments is the ability to increase the turn down capability of the gas turbine system during periods of low demand by storing the thermal energy from the gas turbine generator in the form of heated fluid with a heat exchanger and thermal storage fluid and, preferably, returning that energy later in periods of higher demand.

Another advantage of still further embodiments is the ability to increase the turn down capability of the gas turbine system during periods of low demand by storing the electrical energy consumed in the air booster pump from the gas turbine generator in the form of compressed air and returning that energy later in periods of higher demand while at the same time improving the efficiency of operation by introducing that heated air into the inlet of the gas turbine instead of using compressor bleed air directly.

Another advantage of preferred embodiments is to significantly reduce the cost of the energy storage system by using the existing gas turbine system's compressor, turbine and generator as part of the storage system.

Another advantage of preferred embodiment is to provide additional electrical power generation during peak demand periods that is cost-competitive as compared with other options.

Another advantage of the present invention is the ability to use a resistance type heater in the hot fluid tank to be able to adjust the power output of the gas turbine system instead of turning down the gas turbine system itself. Another advantage of the present invention is the ability to use a resistance type heater in the hot fluid tank to be able to provide rapid grid stability control.

Another advantage of the present invention is the ability to incorporate selective portions of the embodiments on existing gas turbines to achieve specific plant objectives.

Another advantage of preferred embodiments is the ability to incorporate all or portions of the invention into existing bleed systems on gas turbine systems that are used for various reasons that will result in simpler installation and lower costs.

Another advantage of the present embodiment is the ability to inject the air from the storage tank and/or the boost compressor into a turbine cooling circuit, thus recovering all of the heat given up by cooling the air for the storage process is not necessary because cool cooling air is highly desirable.

Accordingly, the In situ Gas Turbine Energy Storage (“IGTES”) system according to one preferred embodiment of the present invention includes an intercooled compression circuit using an air booster pump to produce compressed air that is stored in high pressure air tanks, where the intercooling process heat absorbed from the compressed air is introduced to ambient air and then delivered to the inlet of the gas turbine to improve low flow efficiency and turn down capability of the gas turbine compressor, and a heat storage system that captures a portion of the heat generated in the gas turbine compressor, with heat exchangers between the compressor discharge case air and the intercooler to add heat to the heat storage system during the energy storage process and to add heat to the compressed air being re-introduced to the gas turbine combustion case during periods of increased power output, with an auxiliary induction heater to add additional heat to the thermal storage system as desired, providing a means or mechanism for rapid grid stability control. Optionally, instead of the heat storage system, the heat can be used to provide useful energy to a district heating or combined cycle system. Optionally, when integrated with a combined cycle gas turbine plant with a steam cycle, steam or water from the steam cycle can be used, instead of the thermal storage system, to heat the air exiting the tanks before it enters the gas turbine.

The use of high pressure air storage tanks in conjunction with firing this air directly in the gas turbine gives the gas turbine the ability to deliver much more power than could be otherwise produced because the maximum mass flow of air that is currently delivered by the gas turbine system's compressor to the turbine is supplemented with the air from the air tanks and/or the boost compressor. On existing gas turbines, this can increase the output of a gas turbine system up to the current generator limit on a hot day, which could be as much as an additional 20% power output while at the same time increasing their turn down capability by 25-30% more than current state of the art.

According one embodiment of the invention relates to a method of operating a gas turbine energy system comprising:
(a) operating an existing gas turbine system comprising a compressor, a combustor case, a combustor, and a turbine, fluidly connected to each other;
(b) bleeding extracted pressurized air from (i) said compressor and/or (ii) said combustor case;
(c) storing said extracted pressurized air in an air storage tank and storing thermal energy in a hot fluid tank; and
(d) releasing the pressurized air from the air storage tank, heating it with thermal energy from the hot fluid tank, and injecting the pressurized air into the gas turbine system to increase power from the system.
   Preferably, the method further comprises cooling and pressurizing said extracted pressurized air prior to said storing in said storage tank. Preferably, the cooling and pressurizing of said extracted pressurized air is performed using an intercooler system prior to storing in said storage tank.

According to one preferred embodiment, the method further comprises further pressurizing said extracted pressurized air using an air booster pump prior to said storing in said storage tank. Preferably, the extracted pressurized air is cycled between said air booster bump and an intercooler system at least once for cooling and pressurizing before said storing in said storage tank thereby reducing the temperature and while increasing the pressure for storing in said air storage tank.

According to yet another preferred embodiment, the method further comprises extracting heat from said extracted pressurized air using a heat exchanger system prior to storing in said storage tank.

According to yet another preferred embodiment, the method further comprises extracting heat from said extracted pressurized air using a heat exchanger system prior to said cooling and pressurizing in said intercooler system. Preferably, the heat exchanger system heats a fluid using heat extracted from said extracted pressurized air forming a hot fluid. Preferably, the hot fluid is stored in a hot fluid tank, preferably after being heated.

Advantageously, the preferred methods and systems according the embodiments of the invention allow the gas turbine system to operate at lower load conditions and/or at higher efficiencies. Preferably, providing extra capacity reserves for extreme peaks, or to make up for de-rated generation in hot weather. Preferred methods and systems of the invention enable variable energy to power (MWH/MW) ratios in the range of 1/1 and 4+/1, compared to the fixed 1/1 ratios characteristic of most alternative storage technologies. Unlike batteries, the methods and systems are designed for repetitive full discharge cycles and will last for more than thirty years of intensive use. Preferably, the methods and systems described in this invention provide grid-scale fast response to voltage fluctuation in less than one minute for the power augmentation involving the air compression and injection and in milliseconds for the resistive heating system.

Other advantages, features and characteristics of the present invention, as well as the methods of operation and the functions of the related elements of the structure and the combination of parts will become more apparent upon consideration of the following detailed description and appended claims with reference to the accompanying drawings, all of which form a part of this specification.

### BRIEF DESCRIPTION OF DRAWINGS

FIG. 1 is a schematic drawing of an Insitu Gas Turbine Energy Storage System according to one embodiment of the invention.

FIG. 2 is a schematic drawing of an optional arrangement for an Insitu Gas Turbine Energy Storage System according to another embodiment of the invention.

FIG. 3 is a schematic drawing of an Insitu Gas Turbine Energy Storage System according to another embodiment of the invention integrated into the gas turbine high pressure cooling system.

FIG. 4 is a schematic drawing of an Insitu Gas Turbine Energy Storage System according to another embodiment of the invention integrated into the gas turbine low pressure cooling system.

FIG. 5 is a schematic drawing of an Insitu Gas Turbine Energy Storage System according to another embodiment of the invention integrated into a minimum cost capacity augmentation system according to another embodiment of the invention

### DETAILED DESCRIPTION OF THE INVENTION

One aspect of the invention relates to methods and systems that allow gas turbine systems to run more efficiently under various conditions or modes of operation. In systems such as the one discussed in U.S. Pat. No. 6,305,158 to Nakhamkin (the “'158 patent”), there are three basic modes of operation defined, a normal mode, charging mode, and an air injection mode, but it is limited by the need for an the gas turbine and electrical generator that has the capacity to deliver power “exceeding the full rated power” that the gas turbine system can deliver. The limitation of “exceeding the full rated power” arises from an early patent for air injection into gas turbines, U.S. Pat. No. 2,535,488 issued in 1950 to Dros, which discloses that gas turbines lose power as ambient temperature rises and that there is excess capacity within the existing gas turbine. There are several elements to a gas turbine that limit its “rated power” in its unaltered state, specifically, flow limits, mechanical limits and temperature limits. These limits are experienced at various ambient conditions. For example, a mechanical limit, like the shaft torque, is reached at low ambient temperature conditions. The flow limit is also reached at low ambient temperatures as that is when the flow through the gas turbine is maximized. The temperate limit, for limiting components in the engine like turbine blades, is reached during hot days because the cooling air used to cool these components is hotter. Gas turbine manufacturers build gas turbines in a production environment, and therefore, the gas turbine is designed to operate typically between 0° F. and 120° F. Consequently, “full rated” shaft torque and flow are designed and built into the base gas turbine while “full rated” temperature occurs at 120° F. In order to “exceed full rated capacity” of any of these systems, therefore, the shaft torque capacity, flow capacity, or temperature capacity must be increased. Unfortunately, this is a very expensive modification and that is why there have been no commercial applications of the '158 patent since its issuance 2001. The proposed invention addresses these cost issues.

Also, as outlined in a related U.S. Pat. No. 5,934,063 to Nakhamkin (the “'063 patent”), there is a valve structure that “selectively permits one of the following modes of operation: there is a gas turbine normal operation mode, a mode where air is delivered from the storage system and injected into the gas turbine, and then a charging mode”. The system disclosed in the '063 patent has two significant shortfalls that have resulted in no commercial applications of this technology since the '063 patent issued in 1999. The system disclosed in the '063 patent 1) lacks a practical and efficient method to heat the air up prior to injection and 2) is high in complexity and cost. Although the system can be installed at a simple cycle plant, and the heat from the simple cycle gas turbine used for augmentation, the cost and complexity drives the price too high. Also, whether the system is being used or not, there is an efficiency penalty to the gas turbine due to increased exhaust back pressure. If the system is incorporated into a combined cycle plant, then steam is used to heat the air up, which causes a loss in power in the steam turbine and added plant complexity. The proposed invention outlined below addresses both the cost and performance issues of the '063 patent.

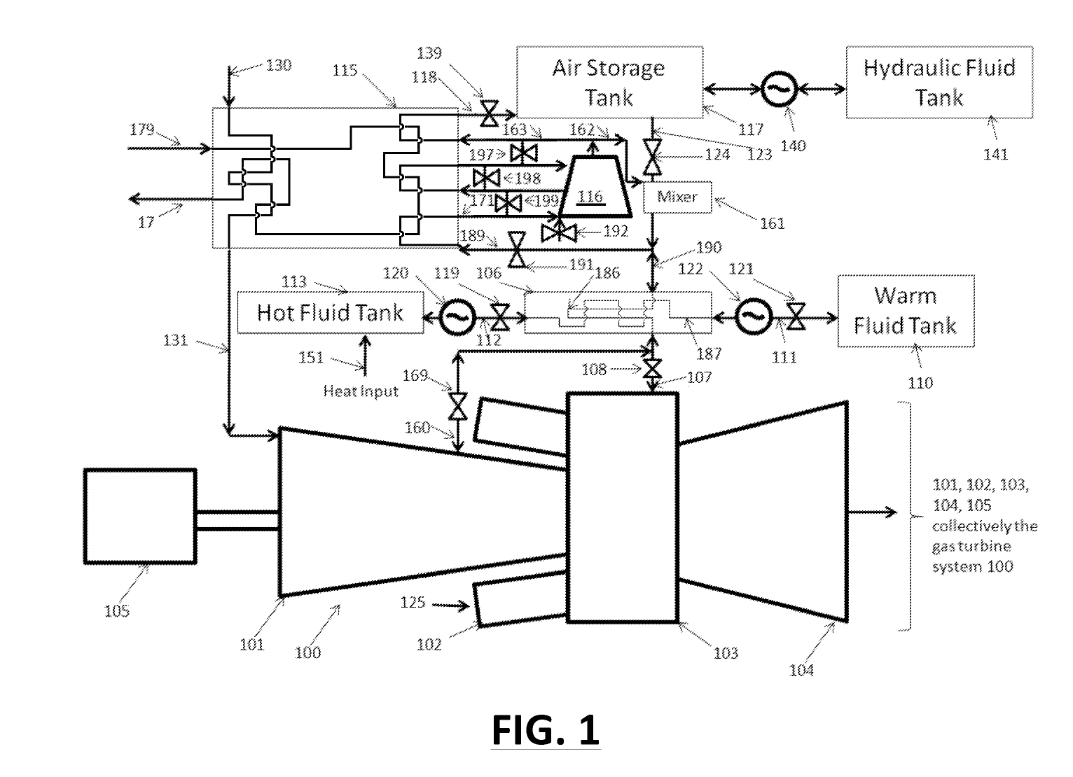

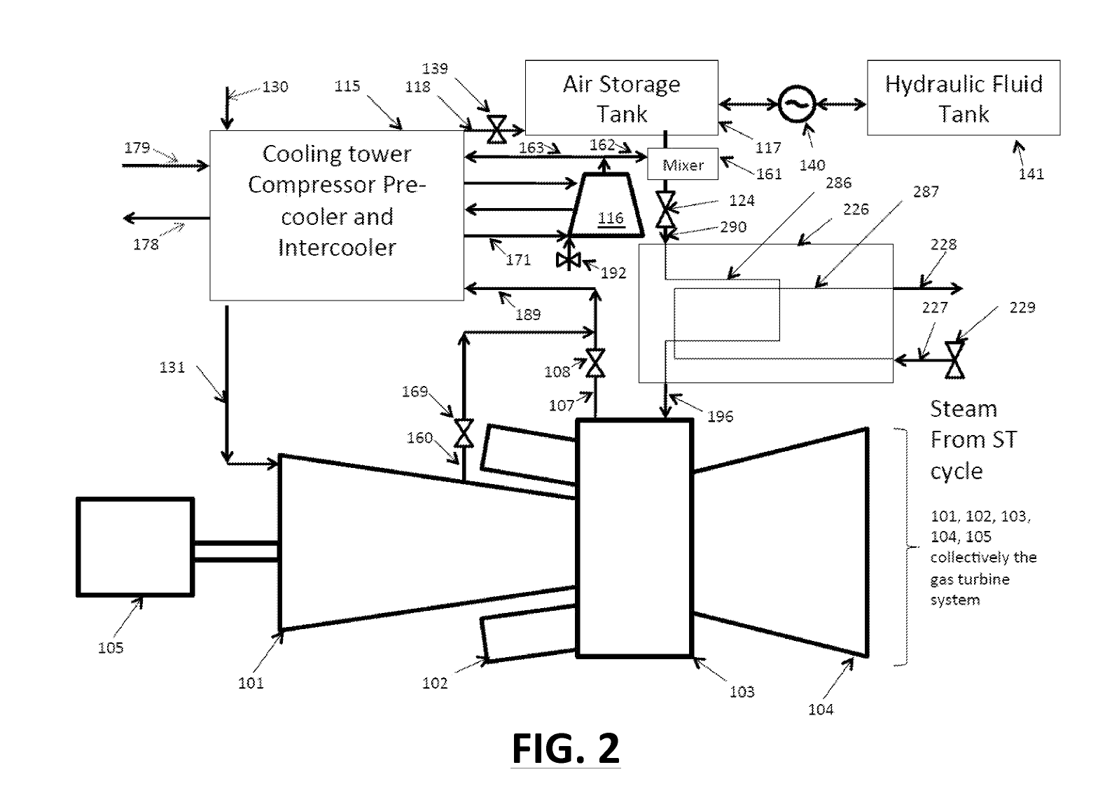

The components of one embodiment of the In situ Gas Turbine Energy Storage System (“IGTES”) of the present invention are shown schematically in FIG. 1 as they are used with an existing gas turbine system 100. The gas turbine system includes a compressor 101, combustor 102, combustion case 103, turbine 104 and generator 105. In this embodiment, during periods when it is desirable for the operator to reduce the power level of the gas turbine system 100 to the electrical grid, air that has been compressed and heated by the compressor 101 is extracted through a combustion case manifold 107 and/or a compressor bleed port 160 by opening the combustion case valve 108 and/or the compressor bleed valve 169, and introduced to the first circuit 186 of the high temperature heat exchanger 106. Preferably, the first heat exchange circuit 186 of the high temperature heat exchanger is in selective fluid communication with a compressed air inlet/outlet of said combustion case 103 through the inlet/outlet flow control valve 108 of the combustor case 103 and compressor inlet/outlet bleed valve 169, and in thermal contact with the second heat exchange circuit 187 of the high temperature heat exchanger. As used herein, the phrase “in thermal contact” means that two or more materials can transfer thermal energy in the form of heat from one to another due to proximity, actual contact, or by being separated only by a barrier across which heat readily transfers. Thus, the second heat exchanger circuit 187 is in thermal contact with the air flowing out of the combustor case manifold 107 and/or the compressor bleed 160 through first heat exchange circuit 186, allowing the heat energy storage fluid flowing through second heat exchanger circuit 187 to receive or extract secondary heat from the source of secondary heat. The intercooler air valve 191 is open and the air tank exit valve 124 is closed. The air exiting the first circuit of high temperature heat exchanger is directed to, and further cooled in, an intercooler 115 and then delivered to the inlet 171 of the high pressure portion of the air booster pump or “ABP” 116. As those skilled in the art will readily appreciate, although referred to herein as an “intercooler”, the intercooler 115 actually includes a pre-cooler, an intercooler, and an after-cooler, as described in greater detail below. Although the flow paths through the intercooler 115 are not shown in FIGS. 2-5, it is understood that the flow paths through the “cooling tower compressor pre-cooler and intercooler” 115 in FIGS. 2-5 are the same as those shown in FIG. 1. With the ambient air inlet valve 192 closed, the air booster pump 116 further increases the pressure of the air through at least one stage of compression, which is then after-cooled in the same intercooler 115, where the exit of the last stage 163 of the air booster pump 116 is then after-cooled in the same intercooler 115, and then the cool high pressure air is delivered to the air tank inlet manifold 118, flows through the air tank inlet valve 139, which is open, and is stored in the air storage tank 117. The outlet of the first heat exchange circuit 190 of the high temperature heat exchanger is in selective fluid communication with the inlet of the first heat exchange circuit of the intercooler through a flow control valve 191. As used herein, the phrase “selective fluid communication” means that fluid or gas can flow therebetween, but that flow can be increased or decreased through the use of a valve or similar flow control device. The second heat exchange circuit 187 of the high temperature heat exchanger is in thermal contact with the air flowing through the first circuit of the high temperature heat exchanger 186, and the heated inlet air is in fluid communication with the source of secondary heat to receive secondary heat therefrom. As the pressurized air flowing through the intercooler 115 is cooled, the heat transferred therefrom can be used to heat atmospheric air flowing to the inlet of the gas turbine to improve the turn down efficiency and capability of the unit. As the atmospheric air entering the intercooler 130 is heated up and exits the intercooler 131 an outlet of the intercooler can be connected to the inlet of the gas turbine or otherwise utilized, or just dumped to atmosphere.

An alternate method to cool the air in the intercooler 115 is to use water from district heating requirements (not shown) or steam cycle, as shown in FIG. 2. With this configuration, heat is captured during both the storage cycle described herein, and the power augmentation cycle described herein. The compressed air can be stored in the air storage tank 117 similar to the process described above and represented in FIG. 1 except the hot fluid storage system 113, heat exchanger 106 and related items can be omitted and replaced with a system that can provide some useful energy to a steam or hot water cycle, for example. After the compressed air storage process is complete, the compressed air is released from the air storage tank 117 and heated with low quality steam heat from the steam turbine cycle (not shown) in a combined cycle power plant or some other process heat that may be available. In this arrangement, the compressed air from the air storage tank 117 is combined with the air exiting the low pressure portion of the air booster pump 116, in the mixer 161. When the steam flow valve 229 is opened, the warm compressed air mixture enters the first circuit 286 of the air steam heater 226 through the air storage tank exit valve 124, and then enters the air-steam heater inlet duct 290. This compressed air is heated by steam (or other fluid as described above) that is extracted from the steam turbine cycle and flows through the second circuit 287 of the air steam heater 226 after the compressed air passes through the air steam heater inlet duct 290. In the air steam heater 226, heat energy is transferred to the mixed compressed air, resulting in a hotter compressed air mixture that is then discharged into the combustion case 103 through a combustion case duct 196, or into a suitable turbine cooling circuit. Steam exiting the second circuit 287 of the air steam heater 226 through the steam exit manifold 228 is cooler than when it entered, and is returned to the steam turbine cycle.

Currently, in order to reduce load in a gas turbine, the system's flow rate is reduced and the system operates at a lower efficiency. By adding resistive heating capability, the turbine can operate at higher load and efficiently and the energy delivered to the grid can be reduced by increasing the resistive load drawn by the heater 151. According to preferred embodiments, by including this heater 151, the hot fluid can be heated above the temperatures at which compressed air is extracted from the gas turbine by using an induction heater 151, which could result in an efficiency improvement if air that is injected into the gas turbine, as described in greater detail below, is hotter, as less fuel will be required to heat the air in the gas turbine to the firing temperature. On a typical combined cycle (“CC”) power plant (i.e. two gas turbines coupled with one steam turbine) using General Electric 7FA gas turbines, approximately 3% energy consumption is added, so if the CC power plant can currently be regulated between 50% and 100% power, (or 50% of nameplate load today), with the system of the present invention, it can be regulated from 47% of nameplate load.

When the air storage tank 117 is full, the compression and bleed process is stopped, and the air tank inlet valve 139 is closed, as well as all of the other fluid and air bleed valves 108, 169, 119, 121, 191. The air tank exit valve 124 remains closed.

According to preferred embodiments, the storage tank 117 is above-ground, preferably on a barge, skid, trailer or other mobile platform and is adapted or configured to be easily installed and transported to minimize on site fabrication and cost. The additional components (excluding the gas turbine system) should add less than 20,000 square feet, preferably less than 15,000 square feet and most preferably less than 10,000 square feet to the overall footprint of the IGTES system. A typical continuous augmentation system takes up 1% of the footprint of the CC plant and delivers from three to five times the power per square foot as compared to the rest of the plant, thus it is very space efficient, and a typical continuous augmentation system with storage system takes up 5% of the footprint of the CC plant and delivers from one to two times the power per square foot of the plant. Preferably, the systems and methods produce at least 10 MW of electric generation for up to at least 4 hours (40 MWh) and completely recharge from an exhausted state in preferably less than 4 hours.

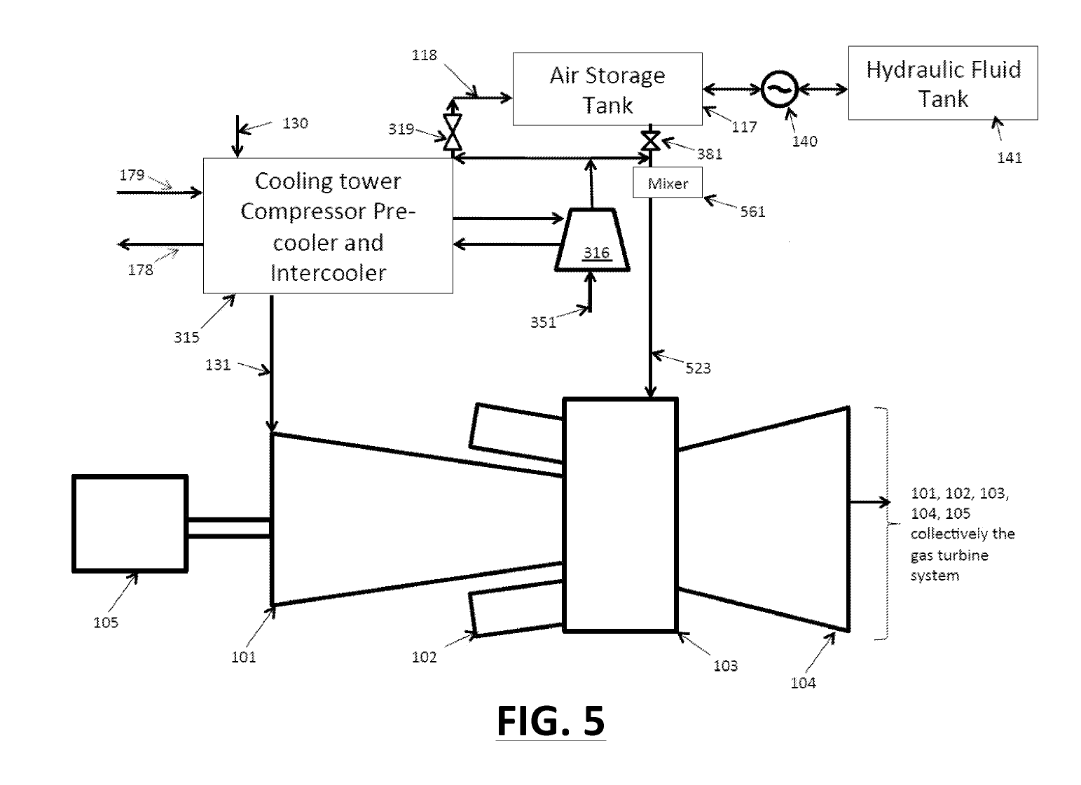

According to preferred embodiments, during periods of increased power delivery, the air exit valve 124 opens, the ambient air inlet valve 192 opens, the hot and warm fluid valves open 119, 121 and the low pressure portion of air booster pump 116 is operated. The air flowing from the exit of low pressure portion of the air booster pump outlet 162 is forced to flow in that direction, as opposed to towards the intercooler 115 through pipe 163, because the air inlet valve 139 is closed. The air flowing from the exit of the low pressure portion of the air booster pump outlet 162 is mixed in the mixer 161 with the air exiting the air tank and introduced to the high temperature heat exchanger 106 where it flows through the first circuit 186 of the high temperature heat exchanger and is introduced into the combustion case 103 using the process described below (the reverse of the air storage process). As those skilled in the art will readily appreciate, since the air being compressed in the air booster pump is bypassing the intercooler, this air exiting the air booster pump via air booster outlet 162 will be hot, and when mixed with the air flowing from the tank via line 123, will increase the temperature of the mixed air 190 entering the high temperature heat exchanger. This is important because this will have a tendency to increase the low temperature of the fluid in the warm fluid tank 110 which will allow for very inexpensive fluid media like molten salt, which has to be kept warm. If the air was simply released from the tank and not warmed in the mixer, the temperature of the warm tank could decrease to the point that the molten salt media would “freeze” and stop flowing altogether. Also, as shown in FIG. 5, to eliminate cost and complexity, the high temperature heat exchanger 106 can be omitted all together, and now the air is heated up only by the mixing process of combining the air from the air storage tank 117 with the air from the air booster pump 116. In addition, since the two fluids are combined, twice as much air can be injected into the gas turbine system 100, resulting in two times the power increase from the gas turbine system 100 without the cost of adding any more equipment. These features are critical to making the IGTES system affordable to customers, and to address the shortfall of how to efficiently heat up the compressed air prior to injection. It also addresses the cost, as the cost is effectively reduced by a factor of two due to obtaining an increase in power that is twice as much with relatively no cost increase.

If efficiency is a key driver, the high temperature heat exchanger 106 as shown in FIG. 1 can be used. With the hot fluid valve 119 and the warm fluid valve 121 open, the hot fluid pump 120 forces the hot thermal fluid from the hot fluid tank 113 through the second circuit 187 of the high temp heat exchanger 106, and with the mixer discharge flow control valve open 124 the preheated air mixture enters the first circuit 186 of the high temperature heat exchanger 106 where it is heated further as heat is transferred from the hot thermal fluid to the preheated air mixture. As the preheated air mixture becomes hotter the thermal fluid becomes cooler and is pumped into the warm fluid tank 110. The compressed air so heated is then discharged into the combustor case 103 and/or the compressor mid-stage case 160 which is controlled by the combustor case valve 108 and the compressor bleed valve 169 to increase mass flow through the turbine 104. By mixing the air from the low pressure portion of the air booster pump 116 with the compressed air from the air storage tank 117, the mass flow of air injected into the gas turbine system 100 is doubled, resulting in twice as much power augmentation from the present system as compared to a system described in the '063 patent, resulting in a significant cost reduction on a per megawatt basis.

A hydraulic fluid option, shown in FIGS. 1-5, can be used to reduce the size requirements of the air storage tank 117. As the combustion turbine continues to be operated in this manner, the pressure of the compressed air in the air storage tank 117 decreases. If the pressure of the compressed air in the air storage tank 117 reaches the pressure of the air in the combustion case 103, compressed air will stop flowing from the air storage tank into the turbine system. To prevent this from happening, as the pressure of the compressed air in the air storage tank 117 approaches the pressure of the air in the combustion case 103, a hydraulic pump 140 begins pumping a fluid, which could be various hydraulic fluids known in the art, but for the purposes of this description will be presumed to be water, from the hydraulic fluid tank 141 into the air storage tank 117 at a pressure high enough to drive the compressed air therein out of the air storage tank 117, thus allowing essentially all of the compressed air in the air storage tank to be delivered to the combustion case 103. During the charging mode, since the water can be gravity fed back into its hydraulic fluid tank 141, the initial pressure of the hydraulic fluid tank 141 can be very close to atmospheric conditions, consequently, initial charging can be accomplished without running the air booster pump 116 at all, improving the efficiency of the air storage process. For example, if the maximum air pressure in the air storage tank 116 is 1200 psi and the gas turbine compressor discharge is 250 psi, when the air pressure in the air storage tank 116 reaches 250 psi, the hydraulic pump 140 would pump water into the air storage tank 116 at 250 psi at the same volumetric flow rate as the compressed air leaving the air storage tank 116. Once the air storage tank 116 is completely filled with water, the hydraulic pump 140 is stopped, the discharge of compressed air from the air storage tank 116 stops, and the valve 124 that controls the flow of compressed air from the air storage tank 117 is closed. Then the water is fed, by the force of gravity, out of the air storage tank 117, leaving the air storage tank 117 at atmospheric conditions. During the charging mode, discharge air from the gas turbine compressor 101 is fed into the air storage tank 117 until the tank 117 reaches 250 psi, resulting in less energy being required by the air booster pump 116 to fill the air storage tank 117 than if the air booster pump 116 alone were used to entirely fill the air storage tank 117.

According to preferred embodiments, independent of whether or not the hydraulic system is used, when the compressed air stops flowing from the air storage tank 117, the low pressure portion of the air booster pump 116 can continue to run and deliver power augmentation to the gas turbine system by taking in air through an ambient inlet valve 192. According to another preferred embodiment, the air booster pump 116 is started and run without use of the air storage tank 117, or in the event the air storage tank 117 is empty. Preferably, an intercooler 115 is used to cool air from a low pressure and high pressure air booster pump 116 that compresses ambient air via inlet valve 192 through a multistage compressor 316 using the intercooler 315. According to another preferred embodiment shown in FIG. 1, a valve system 139, 192, 197, 198, 199 allows air to enter the air storage tank 117 either directly from the atmosphere through the air booster pump 116, or via the gas turbine compressor 101 through valves 169, 191 and the air booster pump 116.

As those skilled in the art will readily appreciate, the preheated air mixture could be introduced into the combustion turbine at other locations, depending on the desired goal. For example, the preheated air mixture could be introduced into the turbine 104 to cool components therein, thereby reducing or eliminating the need to extract bleed air from the compressor 101 to cool these components. Of course, if this were the intended use of the preheated air mixture, the air mixture's desired temperature may be lower, and the mixture ratio in the mixer 161 would need to be changed accordingly, with consideration as to how much heat, if any, is to be added to the preheated air mixture by the high temperature heat exchanger 106 prior to introducing the preheated air mixture to the cooling circuit(s) of the turbine 104. Note that for this intended use, the preheated air mixture could be introduced into the turbine 104 at the same temperature at which the cooling air from the compressor 101 is typically introduced into the turbine 104 TCLA system, or at a cooler temperature to enhance overall combustion turbine efficiency (since less TCLA cooling air would be required to cool the turbine components). Additionally, since a portion or all of the TCLA is being introduced from the air booster pump 116, the pressure can be adjusted if necessary to improve various back flow margin limitations in the TCLA system as well as the providing adequate pressure to the rotor sealing system. Accordingly, yet another embodiment of the above-described method, the air exit valve 124 opens, the ambient air inlet valve 192 opens, the hot and warm fluid valves 119, 121 remain closed and the low pressure portion of air booster pump 116 is operated to pressurize ambient air. The air flowing from the air booster pump 116 is cooled in intercooler 115, flowed via line 163 to be mixed in the mixer 161 and, without being heated by the heat exchanger 106 then introduced into the turbine 104 for cooling.

According to preferred embodiments of the invention, there are three ways for air to get stored into the air storage tank 117. As described, one way is to allow air to enter the storage tank 117 directly from the atmosphere through the low and high pressure portions of the air booster pump 116, the second way is to flow air from the gas turbine compressor 101 then through the high pressure portion of the air booster pump 116, and the third is to flow air from the gas turbine compressor 101 then bypass the air booster pump 116 by opening the intercooler valves (197, 198, 199) and flowing through the intercooler 115 and then into the air storage tank 117. This third way is preferably only used at the initial charge of a previously fully discharged air storage tank, because the gas turbine compressor 101 only provides compressed air up to a pressure of about 250 psi.

However, as shown in FIG. 1, if the valves 169, 124, were open, and the valves 108, 191, 139 were closed, air from the gas turbine compressor 101 would bypass the air booster pump 116 and flow into the air storage tank 117 where it would initially drive the hydraulic fluid out of the air storage tank 117 and back into the hydraulic fluid tank 141, and then air from the gas turbine compressor 101 would continue to flow into the air storage tank 117 until the pressure reached about 250 psi. At that point, the valves 169, 124 would close, and the air storage tank 117 would continue to be filled by one of the other two ways previously described using the air booster pump 116.

By controlling the pressure and temperature of the air entering the turbine system, the gas turbine system's turbine 104 can be operated at increased power because the mass flow of the gas turbine system is effectively increased, which among other things, allows for increased fuel flow 125 into the gas turbine's combustor 102. This increased in fuel flow is similar to the increase in fuel flow associated with cold day operation of the gas turbine system 100 where an increased mass flow through the entire gas turbine system occurs because the ambient air density is greater than it is on a warmer (normal) day.

In summary, the introduction of energy storage in situ to the gas turbine system allows the operator to self-consume a portion of the energy generated by the gas turbine system when minimum output is desired, thus, allowing the system to operate at higher efficiencies and lower output. Additionally, when the system is charging the air storage tank 117, instead of using a high pressure compressor bleed 160 to heat the inlet of the gas turbine to allow it to be run at the extremely low load conditions (or for anti-icing), the heat taken out of the air by the intercooler 115 as the air is compressed can be delivered at low pressures to the inlet of the gas turbine, resulting in an efficiency improvement as well as a method to reduce the output power of the gas turbine system 100, by self-consuming a portion of the load they are generating. During periods of higher energy demand, the compressed air flowing from the air storage tank 117 and the air booster pump 116 is introduced into the air flowing through the gas turbine system 100 directly (e.g. through the combustor case 103), or indirectly (e.g. into the TCLA system) thereby offsetting the need to bleed cooling air from the gas turbine compressor 101, and thereby increasing the net available power of the gas turbine system 100. As those skilled in the art will readily appreciate, since the power output of a gas turbine is very much proportional to the mass flow rate through the gas turbine system 100, and the system described above, as compared to the prior art patents, delivers twice the mass flow rate augmentation to a gas turbine system 100 with the same air storage tank 117 volume and the same air boost pump 116 size, the use of compressed air from the air storage tank 117 and the air booster pump 116 simultaneously to provide compressed air, results in a hybrid system that can cost half the price of prior art compressed air injection systems while providing comparable levels of power augmentation.

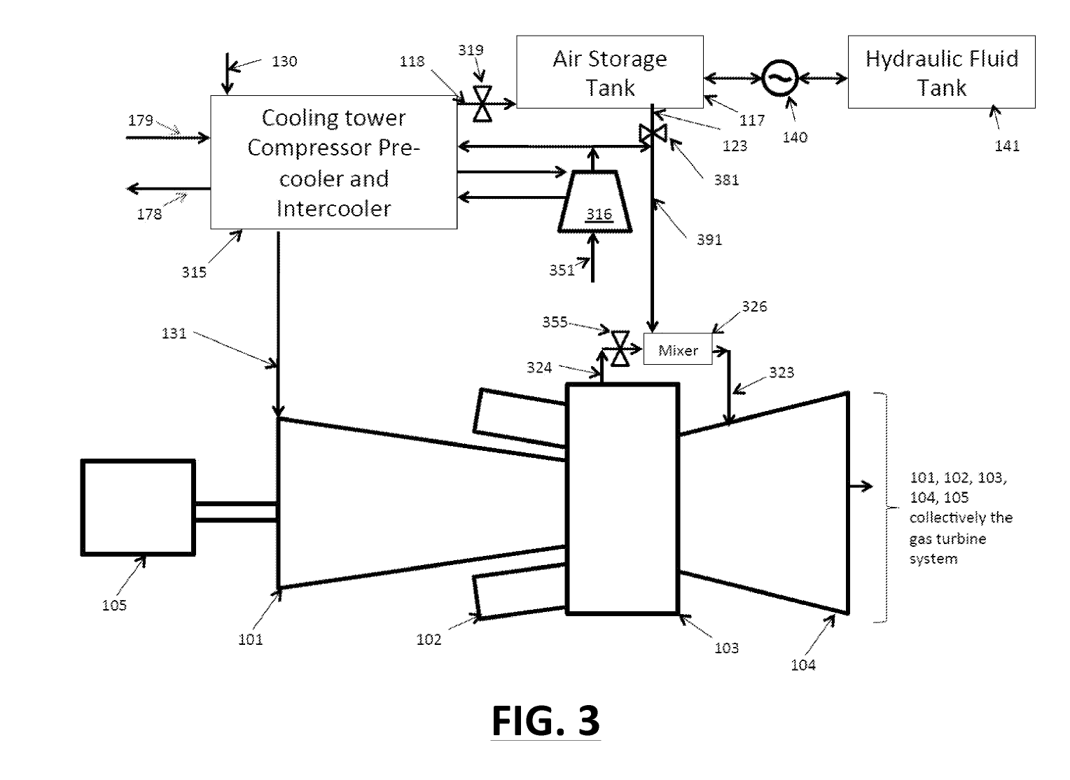

Another alternate embodiment of the invention is shown in FIG. 3, where the augmentation air is taken from the atmosphere, rather than from a combination of the atmosphere and the gas turbine system 100. In this embodiment, an intercooler 315 is used to cool air from a low pressure and high pressure air booster pump 316 that compresses ambient air 351 through a multistage compressor 316 using the intercooler 315. The compressed air flows then into the air storage tank 117 through the air tank inlet manifold 118 with the air exit valve 381 closed. This compression process is typically more efficient than the gas turbine because it is an intercooled process. Once the air storage tank 117 reaches full pressure, the air tank inlet valve 319 is closed, the air booster pump 316 is shut down and the air storage process is complete. When increased net power is needed from the gas turbine system, the air exit valve 381 is opened to immediately deliver additional compressed air to the combustion turbine and the tank inlet valve 319 remains closed. When the air storage tank 117 is empty, the low pressure portion of the air booster pump 316 is started and delivers compressed air to the pipe 391 connected to the inlet valve 381 of the air storage tank 117, bypassing at least a portion of the intercooler 315. In one version of this operational mode, the compressed air comes first from the air storage tank 117, and then comes from the low pressure air booster pump 316 when the pressure in the air storage tank 117 falls to a predetermined pressure, delivering a constant flow rate, and therefore a constant power increase from the gas turbine. In another version of this operational mode, the high and low pressure portions of the air booster pump 316 can be run simultaneously with the compressed air being discharged from the air storage tank 117, effectively prolonging the usable compressed air coming from the air storage tank 117. As those skilled in the art will readily appreciate, there are many other operational modes for the invention shown in FIG. 3. Independent of whether compressed air is coming from the air storage tank 117 or from the air booster pump 316 or some combination thereof, the compressed air flowing therefrom is mixed with air flowing from a TCLA bleed extraction 324, controlled by the bleed valve 355, into a mixer 326 such that a portion of the TCLA bleed air is displaced (i.e. less TCLA needs to be bled from the air compressed by the gas turbine compressor 101). This results in greater air mass flow going through the turbine 104, thus providing power augmentation. The mixed compressed air exiting the mixer 326 and entering the turbine cooling circuit via an inlet 323, can be adjusted to a similar pressure, temperature, and flow rate as the TCLA that was originally being injected, or the output of the mixer 326 can be cooler, higher pressure air, thus requiring less TCLA flow, resulting in a positive effect on the gas turbine system 100 efficiency, and providing increased power augmentation levels.

This same system can be used to improve the turn-down and efficiency of partial load gas turbine system operation. When low power levels are desired and coincide with an opportunity to charge the air storage tank 117, the intercooled low pressure and high pressure air booster pump 316 is operated as discussed above to charge the air storage tank 117, and instead of discharging the warm air from the intercooler 315 to the atmosphere, the warm air 131 can be injected into the inlet of the combustion turbine. Also, at a combined cycle plant, cool water 179 can provide the same intercooling function by warming this cool water and delivering it to the steam cycle 178.

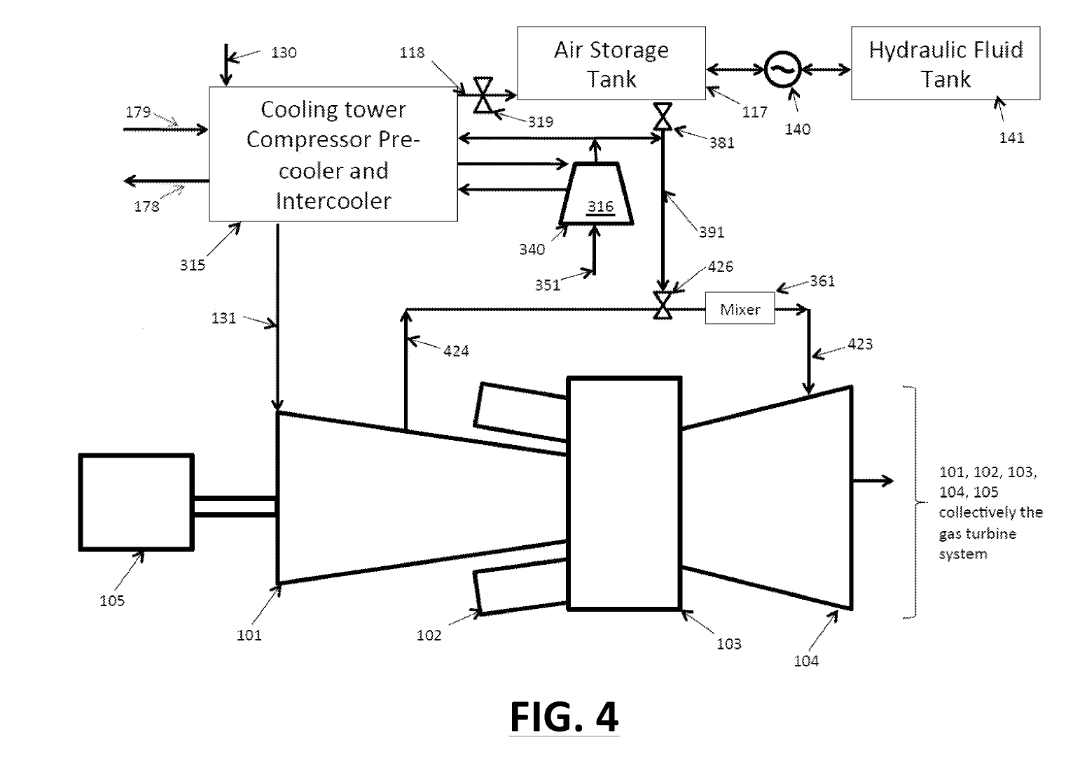

Referring to FIG. 4, an alternate approach is shown that is similar to the operation shown in FIG. 3, however, the air is bled from an intermediate compressor bleed port 424 which is controlled by a bleed valve 426. These two streams are combined in the mixer 361 and when the warm air is delivered from the mixer, it is delivered to a low pressure bleed injection port 423 on the turbine 104 where it displaces low pressure air typically bled from a compressor mid-stage stage bleed 424 of the combustion turbine upstream of the combustion case and delivered to a low pressure TCLA system 423. The mass flow of air that would previously have been bled off now flows through the gas turbine and thus provides power augmentation. The pressure, temperature and flow rate of the compressed air injected into the TCLA air can be controlled as discussed above, yielding efficiency gains.

Referring to FIG. 5, another alternate approach is shown that is very similar to the operation shown in FIGS. 3 and 4, however, the air exiting the low pressure portion of the air booster pump 316 bypasses the cooling tower 315 and gets mixed with the air exiting storage tank 117 in the mixer 561. The warm air is then delivered from the mixer 561 directly to the combustion case 523, thereby increasing the combustion turbine system's power output.

In FIGS. 3, 4 and 5, a heat rate, or efficiency improvement is possible for two reasons. First, the air booster pump 316 being used to deliver the compressed air is more efficient than the efficiency of the gas turbine compressor 101 efficiency due to intercooling of the air booster pump 316, and the compressed air can be controlled so that it is the same temperature, or cooler, than the current TCLA, in which case less cooling air is needed to provide the same function. The efficiency improvement is preferably accomplished without a recuperator, discussed in the prior art, which saves significant capital cost. As shown in FIG. 5, the heat of compression in at least the low pressure air booster pump 316 can be mixed into the compressed air exiting the air storage tank 117 which improves the heat rate or efficiency of the cycle. Furthermore, since none of these proposed technologies use the exhaust from the gas turbine system 100 for heat input, they can be applied to combined cycle plants in a cost effective manner.

Yet another aspect of the invention relates to sub-systems containing two or more of the above-described systems excluding the gas turbine system (e.g., 100 of FIG. 1) for use in modifying existing gas turbine systems. Preferably, the sub-systems comprising the components (e.g., intercooler system, heat exchanger system, air booster pump, hydraulic fluid system and related manifolds, valves and other others) designed, adapted or configured to be assembled with existing gas turbine systems according to the invention.

While the particular systems, components, methods, and devices described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim. It will be appreciated that modifications and variations of the invention are covered by the above teachings and within the purview of the appended claims without departing from the spirit and intended scope of the invention.

1. A method of operating a gas turbine energy system comprising:
(a) providing a storage tank, and an air booster pump;
(b) operating a gas turbine system comprising a compressor, a combustor case, a combustor, and a turbine, fluidly connected to each other;
(c) releasing compressed air from said storage tank at a first temperature and mixing said compressed air with air from said air booster pump which is at a second temperature that is greater than said first temperature, thereby resulting in an air mixture that is at a third temperature that is greater than said first temperature; and
(d) injecting said air mixture into air flowing through the gas turbine system.

2. The method of claim 1 wherein the air mixture is injected into air flowing through said combustor case.

3. The method of claim 1 wherein the air mixture is injected into air flowing through said gas turbine system upstream of said turbine.

4. The method of claim 1 wherein the air mixture is injected into one or more components of said turbine to cool such components.

5-76. (canceled)
